(19) United States
(12) Patent Application Publication
(10) Pub. No.: US 2026/0128957 A1
(43) Pub. Date: May 7, 2026

(54) LARGE LEARNING MODEL FOR ACCESS POINTS

(71) Applicant: Cisco Technology, Inc., San Jose, CA (US)

(72) Inventors: Niloofar Bahadori, Greensboro, NC (US); Arman Rezaee, San Francisco, CA (US); Peiman Amini, Fremont, CA (US); Juan Carlos Zuniga, Montreal (CA); Jerome Henry, Pittsboro, NC (US)

(21) Appl. No.: 19/297,153

(22) Filed: Aug. 12, 2025

Related U.S. Application Data
(60) Provisional application No. 63/714,945, filed on Nov. 1, 2024.

(51) Int. Cl. H04L 41/16; G06F 40/263

(52) U.S. Cl. CPC H04L 41/16; G06F 40/263

(57) ABSTRACT

Techniques to enable streamlining configuration and grouping of access points (APs) within a network. A Large Language Model (LLM) with Natural Language Processing (NLP) capabilities may be integrated into APs to allow administrators to use natural language for network management. The use of an LLM with NLP capabilities reduces the need for specialized technical knowledge to configure and to group APs, and, thus, simplifies AP grouping and configuration tasks. Such a context-aware system offers tailored recommendations for network optimization and simplifies the grouping and config of APs based on location.

### CROSS-REFERENCE TO RELATED APPLICATION

This application claims priority to U.S. Provisional Patent Application No. 63/714,945, filed Nov. 1, 2024, the entirety of which is incorporated herein by reference.

### TECHNICAL FIELD

The present disclosure relates to access points used in wireless networks.

### BACKGROUND

In modern enterprise environments, the demand for robust, flexible, and secure wireless connectivity continues to increase. One key strategy to meet this demand involves configuring groups of wireless Access Points (APs) to work together seamlessly. This approach facilitates applications such as seamless roaming for constant connectivity across different areas, load balancing to manage the network efficiently under relatively heavy usage, and enhanced security policies uniformly applied across substantially all APs. For instance, hospitals require uninterrupted access to patient data as healthcare providers move throughout the facility, and conference venues need to distribute network load effectively during large events to maintain service quality. Additionally, retail chains and hotels generally offer differentiated access levels to staff and guests while managing network security and performance.

The process of grouping and configuring network devices such as APs, access switches, routers, etc., presents several challenges. First, network administrators generally log into the controller for each AP and/or a cloud-based management platform to push configurations to the APs. Such a process of pushing configurations to APs may be time-consuming and prone to errors, especially in large deployments. Second, resources necessary to accurately identify the physical location of each AP within a network, and to effectively group APs with respect to a controller based on their locations or roles, are extensive. Meticulous planning and identifying physical locations of APs and grouping APs can be resource-intensive. Other challenges include scalability issues, configuration consistency, and performance optimizations.

### BRIEF DESCRIPTION OF THE DRAWINGS

FIG. 1 is a diagrammatic representation of a network that includes access points (APs), in accordance with an example embodiment.

FIG. 2 is a block diagram representation of an AP, in accordance with an embodiment.

FIG. 3 is a block diagram representation of a user device which may communicate with a network device such as an AP, in accordance with an embodiment.

FIG. 4 is a flow chart depicting a method for causing a network device such as an AP to perform at least one processing action in response to one or more requests from a user, in accordance with an example embodiment.

FIG. 5 is a diagrammatic representation of an AP in communication with another AP via an access switch, in accordance with an example embodiment.

FIG. 6 is a flow chart depicting a method for causing an AP to communicate and perform at least one processing action on another AP in response to one or more requests from a user, in accordance with an example embodiment

FIG. 7A is a diagrammatic representation of a user interface in which an access point provides information to a user, in accordance with an embodiment.

FIG. 7B is a diagrammatic representation of a user interface in which an access point provides information to a user in response to a query in accordance with an embodiment.

FIG. 8 illustrates a hardware block diagram of a computing device that may perform the functions of a mobile device, a client, a station, an access point, and/or a wireless local area network controller (WLC) referred to herein in connection with the techniques depicted in FIGS. 1-6, 7A and 7B.

### DESCRIPTION OF EXAMPLE EMBODIMENTS

### Overview

Presented herein are techniques which enable a network device such as an access point (AP), access switch, or router to efficiently execute processing actions. A Large Language Model (LLM), as for example a LLM with Natural Language Processing (NLP) capabilities may be integrated substantially directly into an AP. When an LLM is integrated into an AP, the AP may be able to leverage the LLM without latency issues.

According to one embodiment, methods are provided for causing an access point (AP) to execute at least one processing action. One or more requests from a user are received at an AP. The AP determines at least one processing action from the one or more requests using a Large language model integrated into the AP. In response to determining the at least one processing action, the AP causes the at least one processing action to be executed in real-time.

In some aspects, the techniques described herein relate to a method, including: receiving, at an access point, one or more requests from a user; determining, using the AP, at least one processing action from the one or more requests using a Large Language Model integrated into the AP; and causing, using the AP, the at least one processing action to be executed in real-time.

### Example Embodiments

Embodiments are presented herein to enable a network device, for example an access point (AP), to receive requests directly from a user to perform configuration changes with respect to the AP or another AP and, more specifically, using a Natural Language Processing (NLP) model, for example, a Large Language Model (LLM) integrated into the AP. The LLM integrated into the AP is arranged to determine a processing action, including, but not limited to including, addressing a configuration change from a request received from a user, and executing the processing action in real-time.

To meet the demands of wireless connectivity in enterprise environments, wireless APs, which are generally connected to an access switch, may be monitored by administrators, such as network administrators, to configure the APs. Administrators may change the configuration of an AP as needed based, for example, on the changes in services provided by the AP. Generally, a number of APs may be grouped and configured to effectively work together. However, changing the configuration of an AP, or grouping and configuring a number of APs such that they may effectively work together, pose challenges including, but not limited to including, identifying the required configuration of APs, pushing configurations to APs, accurately identifying the location of APs, substantially ensuring that APs are correctly configured and integrated into the correct groups, and dynamically adjusting the configuration of singular APs or grouped APs to improve performance based on real-time data and usage patterns. Such challenges may generally be resource intensive and/or time intensive. In addition, to address the challenges, advanced management tools and expertise may need to be leveraged.

Generally, a user interface may be used in association with a network device, such as an AP, to monitor and change configuration of the AP. Improving the user interface and management tools for configuring and maintaining an AP or even groups of APs is crucial. Improving the user interface and management tools may include, but is not limited to including, automating the discovery, and mapping of APs, simplifying the process of pushing configurations, and/or using artificial intelligence (AI) and machine learning to assist in the improvement, e.g., substantial optimization, of network performance and security policies. Addressing these challenges may enhance network management efficiency, and also significantly improve the end-user experience by supporting a wide range of applications including, but not limited to including, mobile connectivity in large campuses and/or secure and reliable access in critical environments such as hospitals and financial institutions. In one embodiment, a more intuitive, less error-prone, and scalable approach to managing groups of APs may be created. As a result, enterprises may keep pace with the growing demands for wireless connectivity as well as the relatively complex scenarios that networks associated with the enterprises may support.

Accordingly, embodiments are presented herein that enable streamlining the configuration and grouping of network devices, such as APs within a network, using requests from a user. In particular, the embodiments herein use a Natural Language Processing model such as a Large Language Model with Natural Language Processing capabilities that may be integrated into the network devices, such as APs, to allow users such as administrators to use natural language for network management. The use of NLP models such as an LLM with NLP capabilities reduces the need for specialized technical knowledge to configure and to group APs, and, thus, simplifies AP grouping and configuration tasks. Such a context-aware system presented herein offers tailored recommendations for network optimization and simplifies the grouping and configuration of APs based on location.

In one embodiment, network management within the context of configuring and managing groups of wireless APs in enterprise environments involves integrating an LLM directly onto a wireless AP to facilitate interactions between network administrators and their infrastructures.

The use of NLP models, for example, LLMs with advanced NLP capabilities enables network administrators to configure and to manage network devices such as APs through natural language commands. That is, network configurations may be set or adjusted using LLMs with NLP capabilities. This essentially eliminates the need for technical knowledge related to specific configuration languages or protocols, thereby significantly lowering the barrier to effective network management. The ability of an LLM to understand context, and to provide recommendations to a network administrator based on a current network state, historical data, and best practices, facilitates network management. For instance, if an administrator queries about optimizing network performance for a large upcoming event, a system that includes an LLM with NLP capabilities may suggest configuration adjustments specific to expected patterns of use based on the current network state, historical data, and best practices. In one embodiment, a network administrator may be able to group APs together based on their physical location substantially without needing to log into the cloud, or a controller, to select the APs manually to add to a group. In addition, the network administrator may not need to know the location of APs on a map in order to change the configuration of the APs. For example, a network administrator may walk near or under each AP to add substantially all of the APs in a coverage area to a group, and log into the APs directly or as a group to configure them. The AP that is used by the network administrator includes an LLM located and executed on the AP.

In one embodiment, a network administrator may be able to change the configuration or obtain configuration information of an AP, as for example a first AP, by providing commands and/or requests to another AP, as for example a second AP. The AP for which the configuration is to be monitored or changed and the AP to which the administrator may provide a request may be connected to a common access switch. It is to be noted that, in such an embodiment, one AP may be controlled substantially in real-time via another AP, with both of the APs connected to an access switch.

An LLM may interact with network administrators to troubleshoot issues, e.g., in real time. Thus, the use of static troubleshooting guides may be replaced by the LLM which learns from new problems and solutions and, hence, continuously improves the assistance the LLM may provide.

The use of an LLM with NLP effectively ensures that as demands on networks grow, APs may scale management capabilities substantially without compromising security. Advanced encryption may be used for communications, and the understanding of an LLM of security best practices enables the LLM to advise on maintaining network integrity during configuration changes.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description, and appended claims, or may be learned by the practice of embodiments as set forth hereinafter.

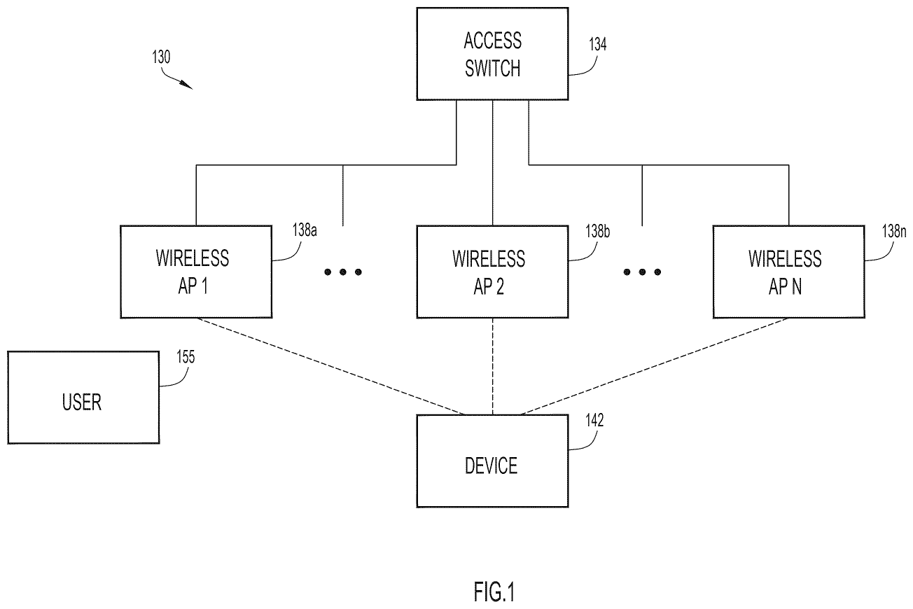

Embodiments will now be described in detail with reference to the figures. FIG. 1 is a diagrammatic representation of a network that includes APs. A network 130 includes an access switch 134 and APs 138a-n. The number of APs 138a-n that are in communication, e.g., communication through wired links, may vary widely. A device 142, which may be a device in the possession of a user of the network 130 may communicate wirelessly with AP 138a, AP 138b, and/or AP 138n as appropriate. For example, as device 142 moves within network 130, device 142 may communicate with different APs 138a-n. In one embodiment, the device 142 may communicate with access switch 134.

In one embodiment, APs 138a-n may each include an NLP model such as an LLM with NLP capabilities. A user 155, such as the network administrator, may be able to monitor or change configuration of any of the APs 138a-n. The user 155 may be able to provide commands to the any of the APs 138a-n to monitor or change the configuration of any of the APs 138a-n. The command from the user 155 may be provided using natural language, i.e., the user 155 may not have to adapt technical language to provide configuration change instructions to any of the APs 138a-n. User 155 may provide the command using a voice command, a verbal command, or a text-based command to a user interface. In one embodiment, access switch 134 may include an NLP model such as an LLM with NLP capabilities. User 155 may be able to provide commands to the access switch 134 using natural language.

An AP, such as one of APs 138a-n, integrated with an LLM may enable network administrators to monitor, change, or update configurations of the AP and to troubleshoot issues in real-time. An LLM onboard AP, such as one of APs 138a-n, may enable configuration changes and troubleshooting by learning new problems and solutions, i.e., learning usage of the AP and continuously improving the ability to render or to otherwise provide assistance. Integrating at least one AP of APs 138a-n in a network with an LLM, ensures that as network demands grow, APs 138a-n can scale management capabilities without compromising security. APs 138a-n using integrated LLMs may be supported by advanced encryption for communications, and may leverage the LLM's understanding of security best practices to advise on maintaining network integrity during configuration changes of the APs 138a-n.

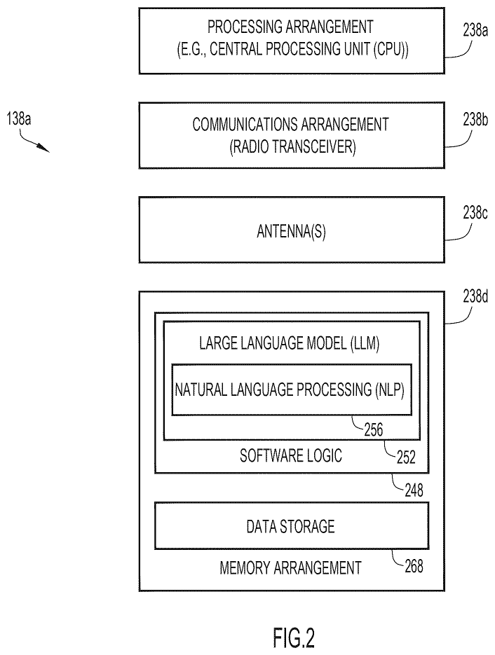

With reference to FIG. 2, an AP will be described in accordance with an embodiment. An AP 138a includes a processing arrangement 238a, a communications arrangement 238b, one or more antennas 238c, and a memory arrangement 238d or other storage arrangement that is integrated with LLM 252. Processing arrangement 238a may generally be a central processing unit (CPU). Communications arrangement 238b may include a radio transceiver. Typically, communications arrangement 238b may be arranged to enable AP 138a to communicate wirelessly and/or over wired links. Communications arrangement 238b may include a microphone (not shown) which acts as a transceiver.

With reference to FIGS. 1 and 2, it should be appreciated that each of the APs, i.e., AP 138b up to AP 138n may generally include the components of AP 138a as described in FIG. 2. That is, while AP 138a is described, the same description may generally be applicable to AP 138b and AP 138n. In some instances, however, AP 138b and AP 138n may differ from AP 138a. For example, in one embodiment, AP 138b and AP 138n may not include an onboard or integrated LLM.

With reference to FIG. 2, it should be appreciated that although an AP is shown, other network devices such as an access switch or a router may include similar components including any natural language processing model to accept commands in natural language, Additionally, it should be appreciated that although an LLM is shown in FIG. 2, in lieu of or in addition to an LLM, any suitable AI model configured for natural language interaction or any suitable natural language processing model may be included in the network device, such as AP 138a. Examples for AI model configured for natural language interaction (or NLP capabilities) include, but are not limited to, an LLM, a Small Language Model (SLM) and any suitable AI model that may perform similar natural language understanding and generation functions, regardless of size or specific underlying architecture.

Memory arrangement 238d includes stored therein, software logic 248 or code devices that include the LLM 252. In one embodiment, LLM 252 may include NLP capabilities 256. The use of LLM 252 with NLP capabilities 256 enables network administrators to configure and manage AP groups, e.g., an AP group that includes APs 138a-n of FIG. 1, through natural language commands.

In one embodiment, a user may be in proximity to AP 138a that includes memory arrangement 238d that is integrated with LLM 252, and communications arrangement 238b that includes a microphone. The user may be able to provide a voice request, for example, to obtain current configuration of AP 138a, or to update a configuration of AP 138a, to the AP 138a using commands in natural (non-technical) language. The microphone included in the communications arrangement 238b may be a far-field microphone configured to detect or to otherwise pick up the voice request from the user at a distance from the AP 138a. In addition, communications arrangement 238b may include a speech to text conversion element (not shown) to process the voice request.

In another embodiment, the user may have access to a user interface of a management tool associated to the AP 138a and may input a text request in non-technical language. LLM 252 including NLP capabilities 256 integrated into AP 138a may be able to interpret the request, such as the voice request or the text request from user and may perform an action, for example, perform obtaining a current configuration of AP 138a, accordingly. Memory arrangement 238d may be able to implement software logic 248 to use LLM 252 integrated in AP 138a, to interpret the commands and perform the action based on the voice request or the text request from user. In one embodiment, in addition to LLM 252, software logic 248 may include other types of artificial intelligence (AI), such as an AI assistant. The AI assistant may use the request interpreted by LLM to interpret additional steps to cause AP 138a to perform an action. LLM 252 may be able to work with the AI assistant to cause AP 138a to perform processing actions using non-technical commands issued by the user.

Memory arrangement 238d may be integrated with a data storage 268. Memory arrangement 238d may be able to use data stored in the data storage 268 to perform an action based on a user's request. In addition, AP 138a may be able to store data that is needed to monitor and to perform configuration changes in the data storage 268.

In another embodiment, memory arrangement 238d may implement software logic 248 configured to perform and/or to support communications with another AP. For example, each of APs 138a-n may include memory arrangements that enable the AP's to communicate with each other. As such, AP 138a may communicate substantially directly with AP 138b. It is to be noted that AP 138a and AP 138b are connected to access switch 134, as shown in FIG. 1. Data storage 268 of an AP 138a may store data related to AP 138a and data that is obtained from communications with other devices on the network 130, including other APs (for example, AP 138b), access switch (for example access switch 134), etc. Data storage 268 may be able to provide data to perform an action for AP 138b using AP 138a without further communication with other devices in the network.

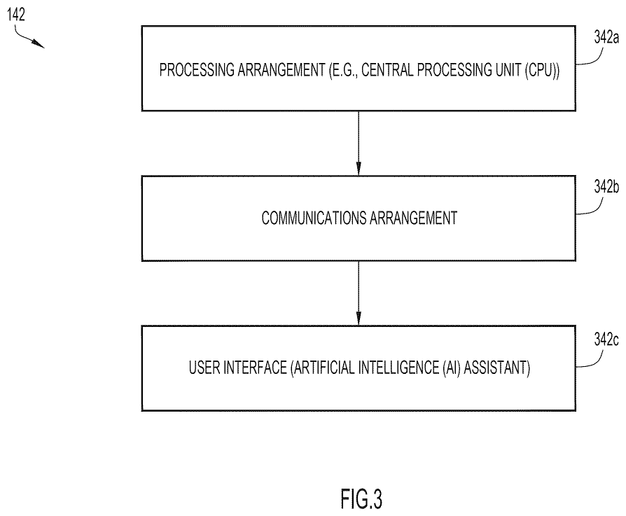

FIG. 3 is a block diagram representation of a user device, as for example device 142 of FIG. 1, which may communicate with a network device, for example, an AP in accordance with an embodiment. User device 142 may generally be used by user, including network administrators, to communicate with APs, e.g., APs 138a-n of FIG. 1 or access switch, e.g., access switch 134 of FIG. 1. For example, user device 142 may be a computing device or a smartphone. User device 142 may include a processing arrangement 342a, a communications arrangement 342b, and a user interface 342c. Communications arrangement 342b may include a microphone to receive voice request from the user. In addition, communications arrangement 342b may include speech to text conversion element (not shown) to process the voice request.

User interface 342c may be arranged to enable device 142 to communicate with APs within a network, e.g., with APs 138a-n within network 130 of FIG. 1. User interface 342c may include a display and a user input device which allows user interface 342c to interact with LLMs associated with APs. User interface 342c may be arranged to enable device 142 to communicate with an AP, for example, AP 138a.

User interface 342c may be arranged to accept a request from device 142 in association to an AP, such as AP 138a. As noted, user interface 342c may accept requests such as a text request in natural language. In one embodiment, user interface 342c may also be arranged to accept a voice request from device 142 using a microphone on device 142. The microphone on device 142 may be arranged to be a transceiver to transmit the voice request received at user device 142 to a transceiver, such as in communications arrangement 238b of AP 138a, shown in FIG. 2.

In one embodiment, user interface 342c may include or may be an AI assistant which facilitates interactions between user device 142 and an AP such as AP 138a of FIG. 2. User interface 342c, may be an AI assistant that is arranged to process requests from device 142, such as, for example, a request to “Set up AP for an event”, without any more information input into the user device 142. The AI assistant may generate commands required to set up the AP for the event, such as making necessary configuration changes to the AP, or obtain configuration information from other APs and/or access switch. AI assistant in the user interface 342c may be able to process the request that is provided in natural language and provide an appropriate command to an AP such as, AP 138a in FIG. 2. In such scenarios, memory arrangement 238d may implement software logic 248 to interpret the command from the AI assistant incorporated in user interface 342c and perform an action accordingly.

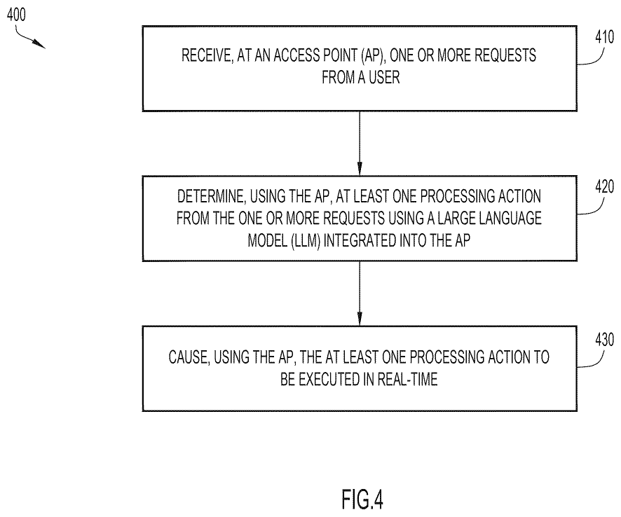

Moving to FIG. 4, a flow chart depicting method 400 for causing a network device to perform at least one processing action in response to one or more requests from a user, in accordance with an example embodiment.

Within a network, network devices such as an AP or an access switch may be interconnected, for example, an AP may be connected to an access switch, as well as to other APs in a network. The network devices may be integrated with any suitable AI model configured for natural language interaction. For example, the AP may be integrated with an LLM or SLM including NLP capabilities. In one embodiment, an access switch may include at least one of an LLM and a SLM with NLP capabilities.

In one embodiment, the network device may include an AI model configured for natural language interaction, such as an LLM (or SLM) with NLP capabilities. FIG. 4 describes an example of the network device, such as an AP. It is to be noted that operations of FIG. 4 may be applicable to any network device including a suitable AI model with NLP capabilities. A user in proximity to the AP may be able to provide one or more requests to the AP. In one embodiment, the user may provide a text request using a user-interface in association to the AP. In one embodiment, the user may provide a voice request directly to the AP. Operation 410 describes the AP receiving the one or more requests from the user. The user interface used to provide the text request or the voice request may be in association to a management tool of the AP. The AP may include a communication arrangement to receive the one or more requests from the user. The communication arrangement may include a radio transceiver to receive and process a voice request from the user.

Operation 420 describes the AP determining at least one processing action from the one or more requests using an LLM integrated into the AP. The AP, on receiving the one or more requests from the user, may use the LLM integrated into the AP to process the requests. The one or more requests provided from the user may be in natural language. An LLM integrated into AP may include NLP capabilities to process the requests provided in natural language and to generate a technical command or a set of technical steps to be performed by the AP. The LLM may interpret the one or more requests from the user to determine or to otherwise identify a processing action to be performed by the AP. A processing action may relate to, but is not limited to, obtaining current configuration of AP, changing configuration of AP, setting up configuration of AP for a particular event, communicating with a neighboring AP and obtaining information of the neighboring AP, changing configurations of a group of neighboring APs, troubleshooting an issue with the AP, etc.

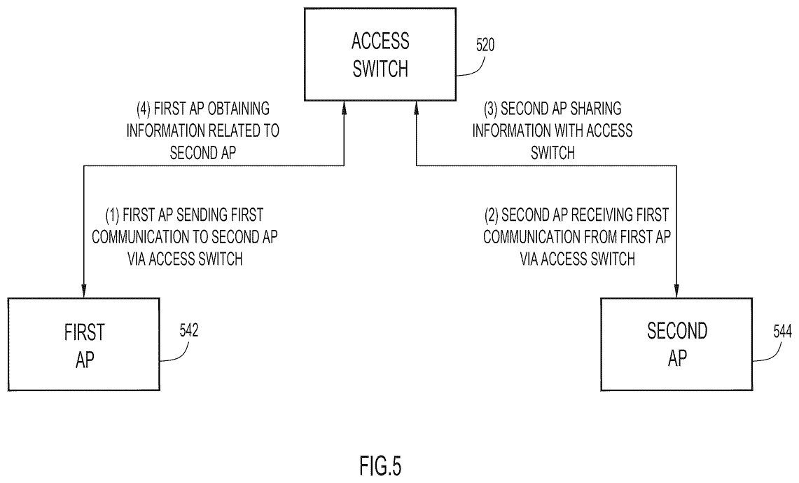

Operation 430 describes causing the at least one processing action determined by the AP to be executed substantially in real-time using the AP. The AP may be able to execute the processing action using data stored in a data storage of the AP. The AP may be able to communicate to a neighboring AP, and to execute a processing action on the neighboring AP or to otherwise cause a processing action to be executed on the neighboring AP. Additionally, an AP may be able to communicate with a neighboring AP such that the data from the neighboring AP may be stored in the data storage of the AP, and the AP may use the stored data to execute future processing actions, e.g., processing actions associated with the neighboring AP. The AP may be able to use an AI assistant to interpret steps involved in executing a processing action. The AP may also be able to use the AI assistant to suggest a processing action to a user based on a current configuration of the AP. Further, the AP may be able to perform troubleshooting substantially in real-time and generate processing actions accordingly. Turning to FIG. 5, a diagrammatic representation of an AP in communication with another AP via an access switch, will be described in accordance with an example embodiment. FIG. 5 shows a first AP 542 in communication with a second AP 544 via an access switch 520. The first AP 542 and the second AP 544 are connected to the access switch 520. As noted, the first AP 542 may be able to receive a command from a user, such as user 155. The command from the user may be, for example, an instruction to “set up APs for an upcoming event,” which may include changing a configuration of more than one AP. The first AP 542 may interpret the command, for example using LLM onboard the first AP 542. The first AP 542 may interpret the command to involve another AP, for example the second AP 544. The first AP 542 may include a data storage, for example, data storage 268 shown in FIG. 2. The first AP 542 may or may not have access to data related to second AP 544 in data storage of first AP 542, which is suitable for use to execute the command when the command involves the second AP 544.

The first AP 542 may send a first communication to the second AP 544 to obtain information that may be used to perform an action related to the command from user. In one embodiment, first AP 542 may send or provide the first communication to the second AP 544 via access switch 520. In another embodiment, first AP 542 may be able to directly communicate with the second AP 544 over wireless communication. The second AP 544, on receiving or obtaining the first communication from the first AP 542, may send or provide a response or a second communication to the first AP 542, directly or via access switch 520. Finally, first AP 542 may receive or obtain the information related to second AP 544 in order to perform the action related to the command from the user, i.e., the command received or obtained at the first AP 542.

The command interpreted by first AP 542 may, for example, include an instruction that is arranged to cause the first AP 542 to execute a processing action on the second AP 544. In such an example, the first communication from first AP 542 to second AP 544 may involve steps for the one or more processing actions that are implemented on second AP 544, i.e., causing the first AP 542 to implement actions on the second AP 544. In particular, the first AP 542 may interpret the processing action using an LLM onboard the first AP 542 and may provide technical commands in the form of processing steps to the second AP 544. The first AP 542 may perform actions on the second AP 544 directly via wireless communication between first AP 542 and second AP 544 or via access switch 520. In other words, first AP 542 may be able to receive a command in natural language from a user and cause execution of a related processing action on second AP 544, using the LLM onboard the first AP 542 to interpret the command, generate technical processing steps and provide the processing steps to the second AP 544 via the first communication.

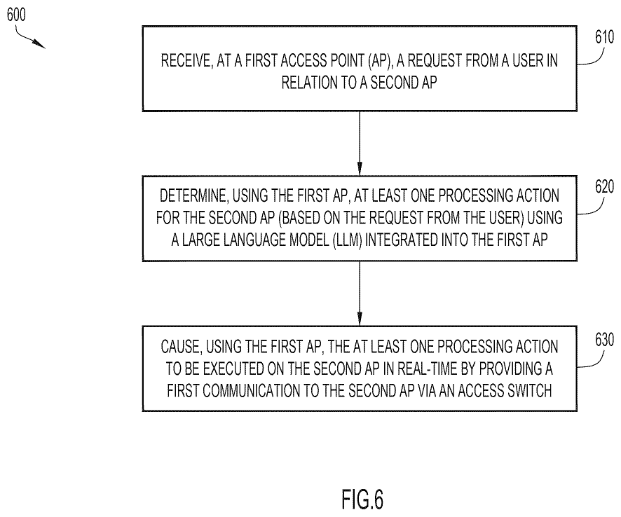

Moving to FIG. 6, a flow chart depicting a method 600 for causing an AP to communicate and perform at least one processing action on another AP in response to one or more requests from a user, in accordance with an example embodiment

Consider a first AP and a second AP connected to an access switch in a network. It is to be noted that there may be other APs connected to the access switch in the network. In one embodiment, the first AP includes an integrated LLM. The second AP may have, in one embodiment, an integrated LLM, but it should be appreciated that the second AP may instead access an LLM that is remote with respect to the second AP. A user may be in physical proximity to the first AP, e.g., the user may walk up to the first AP, and may provide a request or query to the first AP. In one embodiment, the request from the user may be provided to the first AP, but may include a request for information or a request to perform an action with respect to another AP in the network, as for example the second AP. In such a scenario, the user does not have to provide the request to the second AP, the first AP may be able to accept and perform actions related to the second AP.

Operation 610 involves the first AP receiving a request from the user, in which the request is related to the second AP. The user may provide a voice request or a text request directly to the first AP. In one embodiment, the user may provide a voice request or a text request to the first AP using a user interface. As noted, the voice request or the text request from the user may be in natural i.e., non-technical language, for example, “Troubleshoot APs in network for an issue,” or “Troubleshoot APs,” or “Update configuration of second AP.” It is to be noted that the user request may include any processing action to be performed in second AP.

Operation 620 involves the first AP determining a processing action from the request of the user, for the second AP, using LLM integrated in the first AP. The LLM integrated in first AP may interpret the non-technical command from the user and generate at least one processing action to be performed on the second AP. Using the LLM integrated in the first AP, the first AP may be able to perform the processing action on the second AP.

Operation 630 involves causing the processing action to be executed on the second AP using the first AP, by providing a first communication to the second AP, in real-time. The first AP may be able to communicate directly with the second AP, or the first AP may send the first communication to the second AP via the access switch. The first AP may cause execution of the user's command received in natural language, to convert to technical commands in the form of processing steps using LLM. The first AP may directly send such technical commands or processing steps to the second AP via the first communication to execute the processing action defined by the processing steps. The first AP may effectively provide the first communication to the second AP in real-time on receiving the user's request.

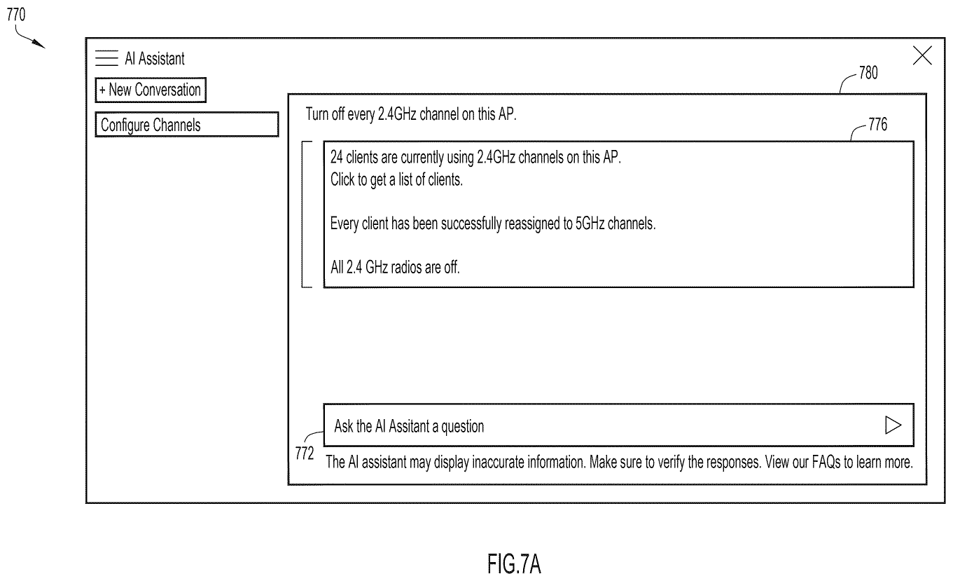

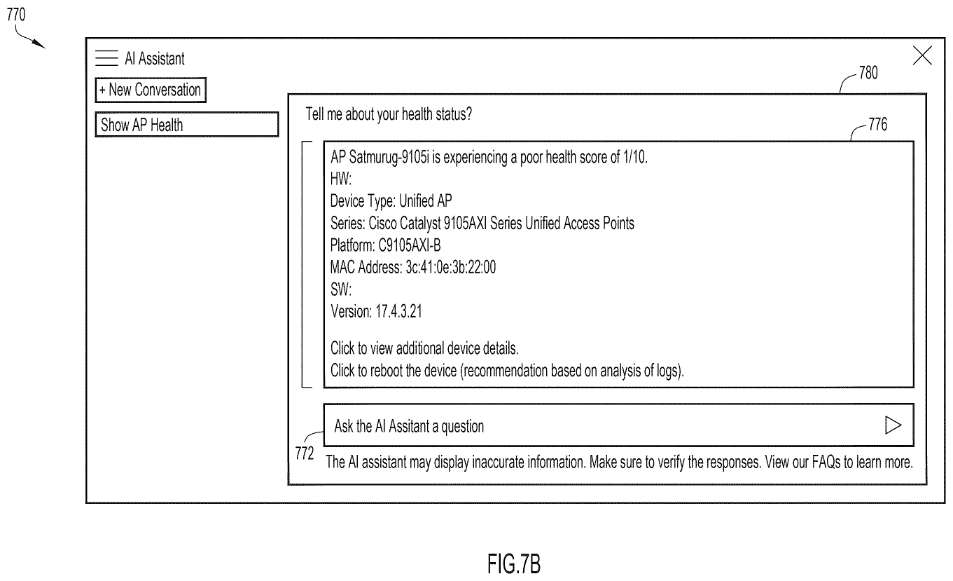

An AI assistant interface associated to an AP may be used to facilitate the ability for a user to obtain information from the AP or to provide instructions to the AP to perform a processing action. The AI assistant interface associated to the AP may include an AI model configured for natural language interaction, for example, an LLM or an SLM. FIGS. 7A and 7B depict an AI assistant interface 770 that includes an LLM or an SLM. The AI assistant interface 770 may enable a user to enter a query or instruction in a field 772. In one embodiment, AI assistant interface 770 may provide the query or instruction to the LLM (or SLM) and the LLM (or SLM) may generate information in response to the query or instruction. The response provided by the AI assistant interface 770, using an LLM (or SLM), may be displayed in a first area 776. The LLM (or SLM) may include NLP capabilities to interpret the query when the query is provided in natural language.

For example, once a query or instruction is entered into field 772, the query or instruction may be displayed in a second area 780, and a response to the query or instruction may be provided in first area 776. As can be seen from FIG. 7A and FIG. 7B, the query as shown in second area 780 is a command in non-technical language. In one embodiment, the query as shown in FIG. 7B in second area 780, may be related to another AP in the network. AI assistant interface may provide response related to another AP in first area 776.

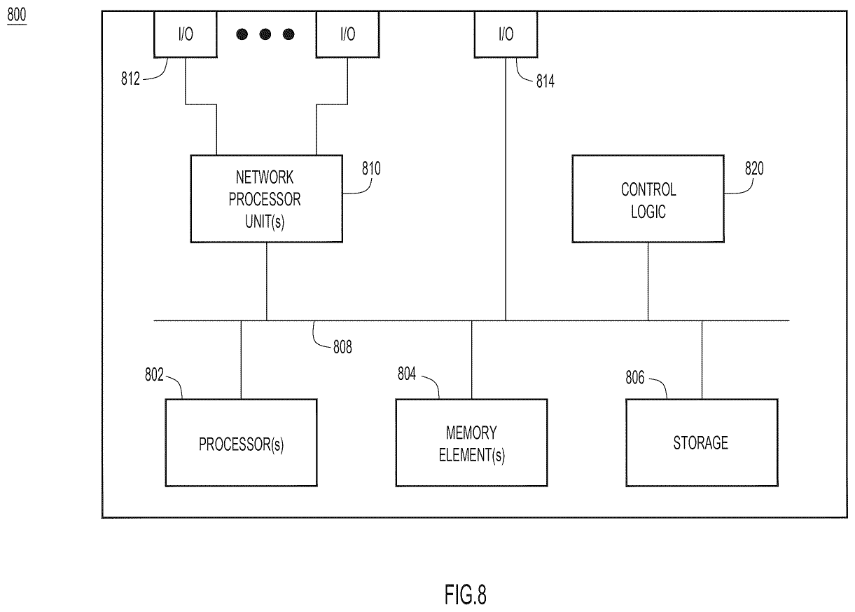

Referring next to FIG. 8, FIG. 8 illustrates a hardware block diagram of a computing device 800 that may perform functions associated with operations discussed herein in connection with the techniques depicted in FIGS. 1-6, 7A, and 7B In various embodiments, a computing device or apparatus, such as computing device 800 or any combination of computing devices 800, may be configured as any entity/entities as discussed for the techniques depicted in connection with FIGS. 1-6, 7A, and 7B in order to perform operations of the various techniques discussed herein.

In at least one embodiment, the computing device 800 may be any apparatus that may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. In various embodiments, network processor unit(s) 810 can be configured as a combination of hardware and/or software, such as one or more Ethernet driver(s) and/or controller(s) or interface cards, Fiber Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method, including: receiving, at an access point (AP), one or more requests from a user; determining, using the AP, at least one processing action from the one or more requests using an Artificial Intelligence (AI) model configured for natural language interaction integrated into the AP; and causing, using the AP, the at least one processing action to be executed in real-time.

In some aspects, the techniques described herein relate to a method, wherein the at least one processing action includes updating a configuration of the AP and performing a troubleshooting of the AP.

In some aspects, the techniques described herein relate to a method, wherein data are stored on the AP and causing the at least one processing action to be executed in real-time includes executing the at least one processing action on the AP using the data.

In some aspects, the techniques described herein relate to a method, wherein causing the at least one processing action to be executed in real-time includes communicating, using the AP, with a neighboring AP.

In some aspects, the techniques described herein relate to a method, wherein communicating using the AP, with the neighboring AP includes communicating using an access switch that is in communication with the AP and the neighboring AP.

In some aspects, the techniques described herein relate to a method, wherein a type of the one or more requests is at least one selected from a group including a verbal request and a text request.

In some aspects, the techniques described herein relate to a method, wherein the Artificial Intelligence (AI) model configured for natural language interaction is at least one of a Large Language Model (LLM) and Small Language Model (SLM) that includes employing Natural Language Processing (NLP).

In some aspects, the techniques described herein relate to a method, wherein the one or more requests includes a verbal request, and wherein the user is in proximity to a location of the AP.

In some aspects, the techniques described herein relate to an access point (AP) system, including: a data storage configured to store data of the AP system; a communication component; at least one processor that is integrated with an Artificial Intelligence (AI) model configured for natural language interaction, wherein the at least one processor is configured to: receive one or more requests from a user; determine at least one processing action from the one or more requests using the AI model configured for natural language interaction; and cause the at least one processing action to be executed in real-time.

In some aspects, the techniques described herein relate to an AP system, wherein the at least one processor is further configured to use data stored on the data storage of the AP system to execute the at least one processing action in real-time.

In some aspects, the techniques described herein relate to an AP system, wherein the at least one processing action includes updating a configuration of the AP system and performing a troubleshooting of the AP system.

In some aspects, the techniques described herein relate to an AP system, wherein the at least one processor is further configured to communicate with a neighboring AP system using an access switch.

In some aspects, the techniques described herein relate to an AP system, wherein a type of the one or more requests is at least one selected from a group including a verbal request and a text request.

In some aspects, the techniques described herein relate to an AP system, wherein the one or more requests includes the verbal request, and wherein the user is in proximity to a location of the AP system.

In some aspects, the techniques described herein relate to an AP system, wherein the AI model configured for natural language interaction is at least one of a Large Language Model (LLM) and a Small Language Model (SLM) that includes employing Natural Language Processing (NLP).

In some aspects, the techniques described herein relate to one or more non-transitory computer readable storage media encoded with instructions that, when executed by a computer processor of an access point (AP), cause the computer processor to perform operations including: receiving, at the AP, one or more requests from a user; determining, using the AP, at least one processing action from the one or more requests using an Artificial Intelligence (AI) model configured for natural language interaction integrated into the AP; and causing, using the AP, the at least one processing action to be executed in real-time.

In some aspects, the techniques described herein relate to one or more non-transitory computer readable storage media, wherein the at least one processing action includes updating a configuration of the AP and performing a troubleshooting of the AP.

In some aspects, the techniques described herein relate to one or more non-transitory computer readable storage media, wherein causing the at least one processing action to be executed in real-time includes communicating, using the AP, with a neighboring AP.

In some aspects, the techniques described herein relate to one or more non-transitory computer readable storage media, wherein a type of the one or more requests is at least one selected from a group including a verbal request and a text request.

In some aspects, the techniques described herein relate to one or more non-transitory computer readable storage media, wherein the AI model configured for natural language interaction is at least one of a Large Language Model (LLM) and a Small Language Model (SLM) including employment of Natural Language Processing (NLP).

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source, and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
receiving, at an access point (AP), one or more requests from a user;
determining, using the AP, at least one processing action from the one or more requests using an Artificial Intelligence (AI) model configured for natural language interaction integrated into the AP; and
causing, using the AP, the at least one processing action to be executed in real-time.

2. The method of claim 1, wherein the at least one processing action includes updating a configuration of the AP and performing a troubleshooting of the AP.

3. The method of claim 1, wherein data are stored on the AP and causing the at least one processing action to be executed in real-time includes executing the at least one processing action on the AP using the data.

4. The method of claim 1, wherein causing the at least one processing action to be executed in real-time includes communicating, using the AP, with a neighboring AP.

5. The method of claim 4, wherein communicating using the AP, with the neighboring AP includes communicating using an access switch that is in communication with the AP and the neighboring AP.

6. The method of claim 1, wherein a type of the one or more requests is at least one selected from a group comprising a verbal request and a text request.

7. The method of claim 6, wherein the Artificial Intelligence (AI) model configured for natural language interaction is at least one of a Large Language Model (LLM) and Small Language Model (SLM) that includes employing Natural Language Processing (NLP).

8. The method of claim 1, wherein the one or more requests includes a verbal request, and wherein the user is in proximity to a location of the AP.

9. An access point (AP) system, comprising:
a data storage configured to store data of the AP system;
a communication component; and
at least one processor that is integrated with an Artificial Intelligence (AI) model configured for natural language interaction, wherein the at least one processor is configured to:
receive one or more requests from a user;
determine at least one processing action from the one or more requests using the AI model configured for natural language interaction; and
cause the at least one processing action to be executed in real-time.

10. The AP system of claim 9, wherein the at least one processor is further configured to use data stored on the data storage of the AP system to execute the at least one processing action in real-time.

11. The AP system of claim 9, wherein the at least one processing action includes updating a configuration of the AP system and performing a troubleshooting of the AP system.

12. The AP system of claim 9, wherein the at least one processor is further configured to communicate with a neighboring AP system using an access switch.

13. The AP system of claim 9, wherein a type of the one or more requests is at least one selected from a group comprising a verbal request and a text request.

14. The AP system of claim 13, wherein the one or more requests includes the verbal request, and wherein the user is in proximity to a location of the AP system.

15. The AP system of claim 9, wherein the AI model configured for natural language interaction is at least one of a Large Language Model (LLM) and a Small Language Model (SLM) that includes employing Natural Language Processing (NLP).

16. One or more non-transitory computer readable storage media encoded with instructions that, when executed by a computer processor of an access point (AP), cause the computer processor to perform operations including:
receiving, at the AP, one or more requests from a user;
determining, using the AP, at least one processing action from the one or more requests using an Artificial Intelligence (AI) model configured for natural language interaction integrated into the AP; and
causing, using the AP, the at least one processing action to be executed in real-time.

17. The one or more non-transitory computer readable storage media of claim 16, wherein the at least one processing action includes updating a configuration of the AP and performing a troubleshooting of the AP.

18. The one or more non-transitory computer readable storage media of claim 16, wherein causing the at least one processing action to be executed in real-time includes communicating, using the AP, with a neighboring AP.

19. The one or more non-transitory computer readable storage media of claim 16, wherein a type of the one or more requests is at least one selected from a group comprising a verbal request and a text request.

20. The one or more non-transitory computer readable storage media of claim 16, wherein the AI model configured for natural language interaction is at least one of a Large Language Model (LLM) and a Small Language Model (SLM) including employment of Natural Language Processing (NLP).
